(19) United States
(12) Patent Application Publication
(10) Pub. No.: US 2024/0290941 A1
(43) Pub. Date: Aug. 29, 2024

(54) PRELITHIATION BY COMPOSITE LITHIUM

(71) Applicant: Our Next Energy, Inc., Novi, MI (US)

(72) Inventors: Qingcheng Zeng, San Jose, CA (US); Peyman Sirous, San Jose, CA (US)

(21) Appl. No.: 18/590,608

(22) Filed: Feb. 28, 2024

Related U.S. Application Data
(60) Provisional application No. 63/448,886, filed on Feb. 28, 2023.

(51) Int. Cl. H01M 4/04; H01M 4/62

(52) U.S. Cl. CPC H01M 4/0435; H01M 4/0404; H01M 4/62

(57) ABSTRACT

Prelithiating a cell with an initial amount of lithium by providing a substrate and generating lithium and a filler material in an amount ratio of filler material to lithium for use as components of a composite lithium. The lithium and the filler material are disposed, by pressure processing using a pressure processing machine, onto the substrate. Disposing of the lithium and the filler material is performed at the same time or sequentially. The substrate with the composite lithium is then placed into the cell.

### BACKGROUND

### Technical Field

The present disclosure generally relates to prelithiation of battery cells and more particularly to prelithiating a cell using composite lithium material.

### Description of the Related Art

In a cell, lithium ions may be driven from the positive electrode to the negative electrode to store energy and may be moved back from the negative electrode to the positive electrode to release energy. In a cell, some of the lithium ions may engage in side reactions that prohibit them from enhancing the battery's ability to store energy.

Typically, the lithium inventory in a lithium-ion cell is supplied completely by lithium-containing cathode active material.

### BRIEF SUMMARY

According to an embodiment of the present disclosure a method of prelithiating a cell with an initial amount of lithium is disclosed. In the method, a substrate is provided and lithium and a filler material are generated in a predetermined amount ratio of filler material to lithium for use as components of a composite lithium. The lithium and the filler material are disposed, by pressure processing using a pressure processing machine, onto the substrate. Disposing of the lithium and the filler material is performed at the same time or sequentially. The substrate with the composite lithium is then placed, along with other electrodes or separator into the cell.

In an embodiment, the method meets constrains including (i) an active lithium content consideration of the cell during use and (ii) a minimum material thickness consideration of the pressure processing machine during manufacturing by sizing an amount of the filler material and selecting the amount ratio to thicken the composite lithium to a thickness producible by the pressure processing machine while maintaining control over the initial amount of lithium material needed prior to a first charge-discharge cycle of the cell.

According to an embodiment, a cell is disclosed. The cell includes a substrate, and a layer of pressure processed composite lithium pressure bonded to the substrate. The layer of pressure processed composite lithium includes lithium and a filler material in a predetermined amount ratio of filler material to lithium.

The substrate may be or include an anode, separator, cathode or current collector.

### BRIEF DESCRIPTION OF THE DRAWINGS

To easily identify the discussion of any particular element or act, the most significant digit or digits in a reference number refer to the figure number in which that element is first introduced.

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps

FIG. 1 depicts a perspective view of a roller and a prelithiated substrate in which illustrative embodiments may be implemented;

FIG. 2 depicts a routine in which illustrative embodiments may be implemented;

FIG. 3 depicts a sketch illustrating a composite lithium material in which illustrative embodiments may be implemented;

FIG. 4 depicts a sketch illustrating another composite lithium material in which illustrative embodiments may be implemented;

FIG. 5 depicts a sketch illustrating another composite lithium material in which illustrative embodiments may be implemented;

FIG. 6 depicts a cross-sectional view of a substrate with a lithium composite on one side of the substrate in accordance with illustrative embodiments;

FIG. 7 depicts a cross-sectional view of a cell with cathode/cathode current collector substrate in accordance with illustrative embodiments;

FIG. 8 depicts a cross-sectional view of a cell with separator substrate in accordance with illustrative embodiments;

FIG. 9 depicts a cross-sectional view of a cell with an anode/anode current collector substrate in accordance with illustrative embodiments;

FIG. 10 depicts a functional block diagram of a computer hardware platform in accordance with one embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, and/or components have been described at a relatively high-level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a cell. As used herein, the term “vertical” describes an orientation that is arranged perpendicular to the first surface of a cell.

As used herein, the terms “coupled” and/or “electrically coupled” are not meant to mean that the elements must be directly coupled together-intervening elements may be provided between the “coupled” or “electrically coupled” elements. In contrast, if an element is referred to as being “directly connected” or “directly coupled” to another element, there are no intervening elements present. The term “electrically connected” refers to an electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used, and structural or logical changes may be made without departing from the spirit and scope defined by the claims. The description of the embodiments is not limiting. In particular, elements of the embodiments described hereinafter may be combined with elements of different embodiments.

For the sake of brevity, conventional techniques related to battery cells, their fabrication and prelithiation may or may not be described in detail herein. Moreover, the various tasks and process steps described herein can be incorporated into a more comprehensive procedure or process having additional steps or functionality not described in detail herein. In particular, various steps in the manufacture of cells are well known and so, in the interest of brevity, many conventional steps will only be mentioned briefly herein or will be omitted entirely without providing the well-known process details.

Turning now to an overview of technologies that generally relate to the present teachings, it is recognized that the first charging process, in which lithium ions and electrons move from cathode to anode, is important for battery operation. Under certain conditions, an electrolyte may be reduced to form a layer of solid electrolyte interphase (SEI) on the negative or positive electrode of a cell. In addition, some lithium may be trapped in the electrode upon lithiation. As a result, the first charging process of a cell may irreversibly consume a fraction of the lithium ions, giving rise to a net loss of storage capacity. More specifically, batteries such as lithium-ion batteries may incur active lithium loss due to lithium consuming parasitic processes such as the creation of the solid electrolyte interphase (SEI) at the negative electrode (anode), active material loss or irreversible lithium metal plating. High surface area carbons and graphites may result in even more SEI formation and thus higher active lithium loss. Successful commercialization of various battery types may depend on overcoming first cycle capacity loss with the addition of extra lithium.

The illustrative embodiments recognize that forming and handling material for prelithiation processes may be excessively complex or particularly restrictive. For example, ultra-thin layers of material may be formed through various techniques such as Physical Vapor Deposition (PVD), Chemical Vapor Deposition (CVD), Atomic Layer Deposition (ALD), and others. These techniques may involve depositing material onto a substrate to form a very thin and uniform layer with precise control over thickness and composition. These techniques may however be highly exorbitant. On the other hand, a standard compressive device employed to create layers of lithium for prelithiation may possess inherent dimensional limitations such as the minimum producible thickness of a layer of compressed or rolled material. The illustrative embodiments recognize that this may cause the fabrication of a layer of lithium that can be thicker than necessary. These dimensional constraints may invariably make prelithiation on a large-scale cost-prohibitive and compromise control over the quantities of lithium used in prelithiation for a first charge-discharge cycle. The illustrative embodiments further recognize that it the degree of prelithiation is difficult to control and it is exceptionally difficult to handle ultra-thin lithium, achieve and keep the properties and technical requirements of lithium foils intact, and the surface and purity of lithium unimpaired.

The illustrative embodiments disclose a method of prelithiating a cell with a direct source of lithium by providing an initial amount of ultra-thin lithium through providing a substrate, generating lithium and a filler material in an amount ratio (for example, a ratio from 1:4 to 4:1, such as or a ratio from 1:2 to 4:1 or a ratio from 1:1 to 4:1 or a ratio from 1:4 to 1:2) of filler material to lithium for use as components of a composite lithium, disposing, by bonding using a pressure processing device, the lithium and the filler material onto the substrate, the disposing of the lithium and the filler material is performed at a same time or sequentially, and placing the substrate laminated with the composite lithium into a cell. An ultra-thin layer may have a thickness of, for example, less than 20μ m or less than 10μ m or less than 5μ m or less than 3μ m. In an illustrative embodiment, The bonding may be achieved by pressure processing techniques of applying pressure to one or more materials to reduce the effective thickness, form an ultra-thin layer (or ribbon-like shape) and/or affix them together using techniques such as calendering, hot pressing, roll bonding, crushing, lamination, extrusion, etc.

For example, hot pressing may comprise applying pressure and heat to a substrate, which may cause it to deform and form an ultra-thin layer. The pressure and heat can be adjusted to control the thickness and other properties of the layer. A hot press device may form layers having a minimum possible material thickness due to dimensional constraints of the device. Methods Lamination may comprise placing the substrate between two or more layers of material and applying pressure to bond the layers together. The pressure can cause the substrate to deform, resulting in the formation of an ultra-thin layer. Lamination machines may also form layers having a minimum possible material thickness. Calendering may involve passing a substrate material through a set of two or more rolls, which may apply pressure to the substrate and cause it to deform. The pressure applied by the rolls can cause the substrate to become thinner and more uniform, leading to the formation of an ultra-thin layer. Likewise, calender machines may possess minimum material thickness considerations. Roll bonding may involve passing the substrate between two or more rolls, which apply pressure and heat to bond two or more layers of material together. The pressure can cause the substrate to deform, resulting in the formation of an ultra-thin layer. Roll bonding may also form layers having a minimum possible material thickness. Of course, these pressure processing techniques are not limiting and others may be obtained in view of descriptions herein.

The illustrative embodiments improve 1st cycle Coulombic efficiency by prelithiation using composite lithium produced by systems and processes described herein that bypass minimum thickness considerations or restrictions inherent in roller devices. In some cases, 1st cycle Coulombic efficiency may be improved from, for example 70% or even lower to as high as 100%. Further, by controlling the location of the lithium layer, one may reduce dendrite formation and improve plating and cell mechanical properties, which will improve cycle life and safety.

More generally, the illustrative embodiments disclose prelithiating cells using composite lithium material that simplifies lithium foil handling and enhances control of the lithium content of the composite lithium material by obviating a minimum thickness requirement of pressure processing machine. In one aspect, after the first charge-discharge cycle of the cell, an active lithium content of the cell is enhanced by reducing or eliminating the net loss of lithium in the cathode after a first cycle.

### Example Architecture

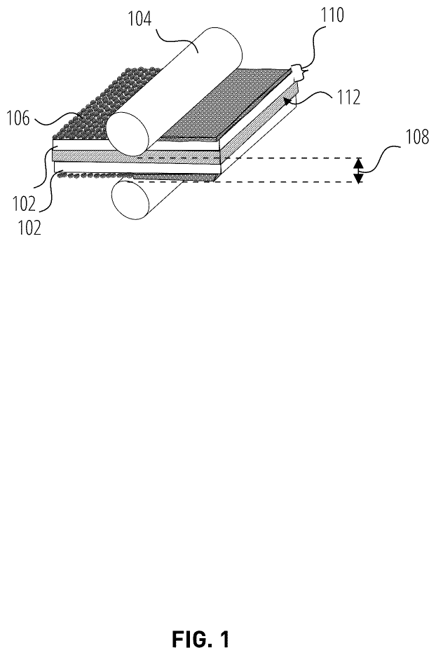

Turning now to FIG. 1, a perspective view of a pressure processing machine 104 and a substrate 112 is illustrated. The pressure processing machine 104 may be a roller and may be used to apply pressure to a lithium foil 102 and a filler material 106 disposed on the lithium foil 102 to form a layer of composite lithium 110 on the substrate 112. The pressure processing machine 104 may also be used separately to apply pressure to a single material such as the lithium in series of calendering and annealing steps to achieve a final thickness and/or other material property.

Due to the use of the filler material 106, the amount of lithium used may be reduced. In an illustrative embodiment, the filler material 106 may be active or inert. Further, the pressure processing may be performed in a dry room. The pressure processing machine 104 may possess a minimum material thickness consideration 108 which may be the minimum thickness of any material or combination of materials produced after passing through or being processed by the pressure processing machine 104.

The substrate 112 may be an anode, a separator, cathode, or a current collector as discussed herein.

The filler material 106 may be inert in one embodiment but may also be reactive with lithium in another embodiment. Further, the filler material 106 may be a ceramic that is selected from, for example, the list consisting of Al₂O₃, and AlOOH. The filler material 106 may alternatively be a polymer and the polymer may be selected from, for example, PAA, PMMA, PVDF, PP, and PE, or combinations thereof. The filler material 106 may also be a metal or any combination of a ceramic and a polymer. For lithium metal cells, the filler material may be selected from, for example, Cu, Brass, or Zn. Other options for the filler may include Boehmite or SiO₂.

Upon prelithiating the substrate 112, the prelithiated substrate along with the remaining electrodes or separator may be inserted into a cell housing to form the cell. In some embodiments, the prelithiation of the substrate may be performed in situ while the substrate is in the cell housing.

In another aspect, the cell may be any cell such as a lithium-ion cell, a lithium metal cell or an anode-free cell. Anode-free, anode-less or initial anode-free cells, are a type of lithium metal cells. Lithium-metal cells may work in a similar fashion to lithium-ion cells but instead of using a graphite anode host material, may use a high-energy lithium metal. Anode-free lithium (Li) metal cells are lithium metal cells that may be manufactured without a lithium metal anode, or any other anode host material, such as graphite, titanate, iron-oxide, silicon, silicon-oxide. In some cases, the anode-free cells may be cells wherein a lithium anode is subsequently generated, after manufacturing, in operando inside the cell during operation as the cell changes under an external influence when the cell is charged the first time. In other cases, anode-free cells may be cells that have a ratio of anode capacity to cathode capacity being less than 1 when the cell in a fully charged state. In other words, all lithium may be removed from the cathode when the cell is fully charged. Lithium ions, provided by the cathode active material, are deposited as metallic lithium onto a metal substrate, such as copper or nickel foil or mesh to create the working cell. Though anode-free, anode-less or initial anode-free cells are discussed herein, these are not meant to be limiting as the methods and systems may also equally apply to other cells in general.

### Method

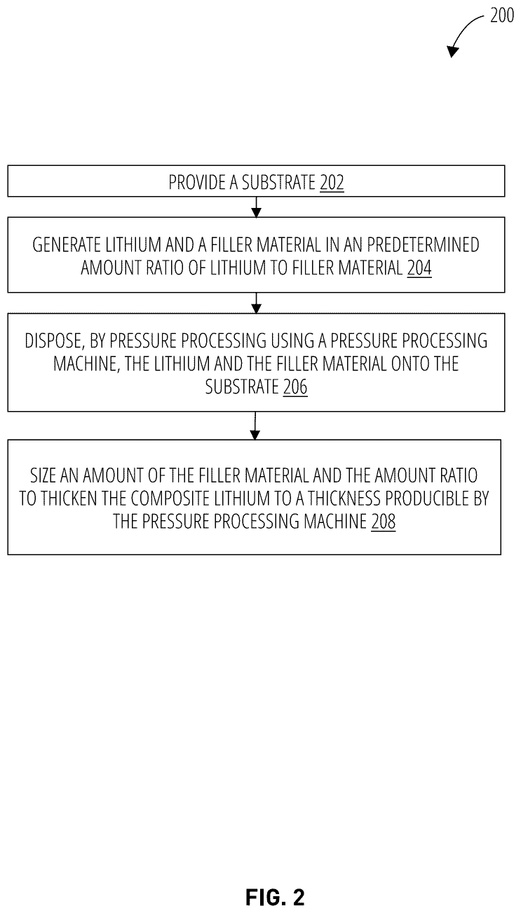

Turning now to FIG. 2, a routine 200 in which illustrative embodiments may be implemented is disclosed. In one aspect, the routine 200 may be applicable to prelithiation processes wherein an electrode material may be mixed with a lithium containing composite and subjected to high-pressure and/or high-temperature conditions. In block 202 of the routine, a substrate is provided. In block 204, lithium material (such as a lithium foil 102) and a filler material 106 are generated an amount ratio (for example, a predetermined amount ratio) of filler material to lithium for use as components of a composite lithium. In block 206, the lithium and filler material are disposed, by pressure processing or bonding with at least the application of pressure using the pressure processing machine 104, onto the substrate; the disposing of the lithium and the filler material may be performed at a same time or sequentially as discussed hereinafter. In block 208, two constraints namely (i) an active lithium content consideration of the cell during use and (ii) a minimum material thickness consideration of the pressure processing machine 104 during manufacturing are met by sizing the amount of the filler material 106 and the amount ratio to thicken or define a thickness of the composite lithium to be a thickness producible by the pressure processing machine 104. Due to flexibility in choosing the amount of the filler material, the initial amount of lithium material needed for prelithiation is maintained, thus giving one the ability to use just the right amount of lithium to produce a prelithiated substrate. Constraints on lithium thickness introduced by the minimum material thickness consideration 108 are thus, bypassed giving more control over the lithium content used for prelithiation. The prelithiated substrate may be placed into a cell which may be an anode-free cell.

In an aspect, generating the filler material and lithium material and/or the disposing filler material and lithium material onto the substrate are performed under a plurality of predetermined process conditions including predetermined temperature, duration and pressure.

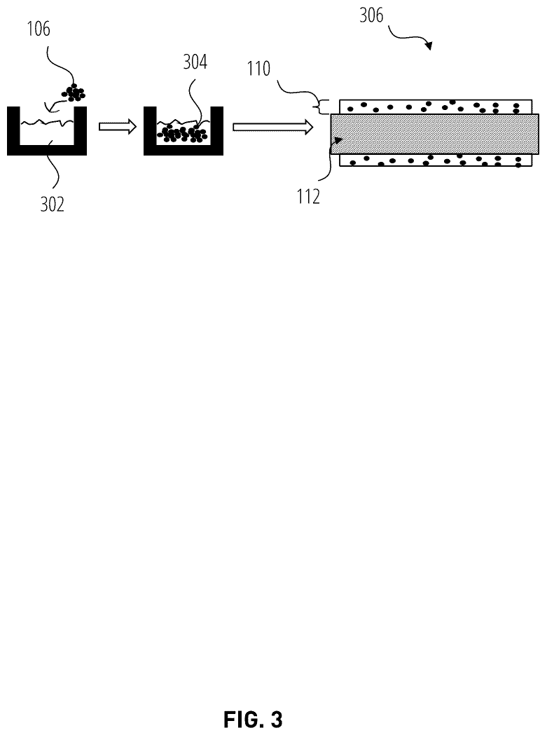

In one aspect, as shown in FIG. 3 the composite lithium 110 may be formed by mixing lithium 302 with the filler material 106 to generate a lithium-filler material mixture 304. Based on the filler material selected for mixing, the lithium 302 may be made easier to handle and control. The mixing can be performed via, for example, mechanical agitation (ball milling, etc.), folding, reaction and forming within Li, force embedding (pressing, rolling, etc.), annealing, extrusion, etc. Thus, the lithium is dispersed evenly throughout the mixture.

The lithium-filler material mixture 304 may then be deposited on the substrate 112 and bonded thereon by a pressure processing machine 104 to form a prelithiated substrate 306. In an exemplary embodiment, the composite may be formed into a ribbon and laminated on a substrate foil (e.g., Cu) together with a liner material (not shown) on each side. A liner may be especially beneficial when the substrate is a current collector substrate.

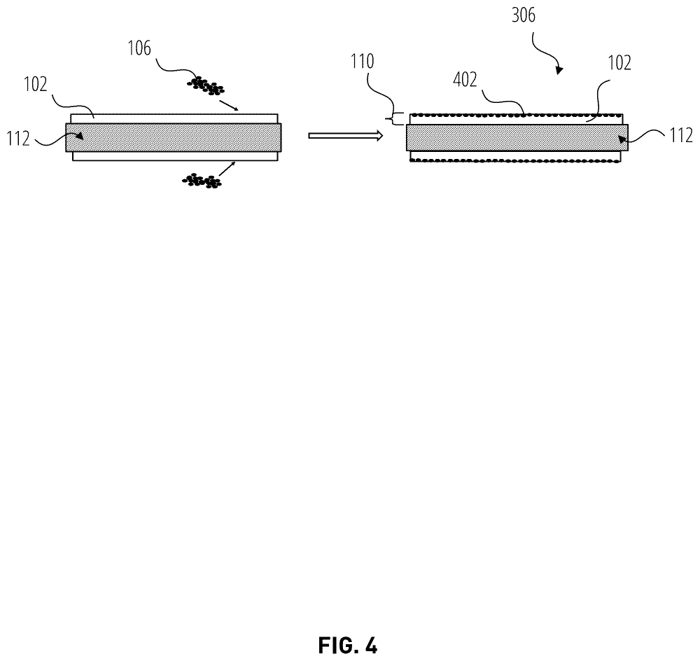

Turning to FIG. 4, the lithium material can be a lithium foil and pressure processing the composite lithium onto one or both sides the substrate can include sequentially bonding the lithium foil onto the substrate and the filler material onto the lithium foil.

More specifically, In FIG. 4, a composite lithium material is shown wherein the composite lithium 110 comprises a surface filler material 402 disposed on a lithium foil 102. The surface filler material 402 may be located on an outside periphery (outside boundary) of the lithium foil 102. By passing the substrate 112 with the composite lithium 110 through pressure processing machine 104 the composite lithium 110 may be bonded to the substrate 112. More specifically, the lithium foil 102 may be bonded on the substrate 112 by the pressure processing machine 104. Subsequently, the filler material 106 such as a filler powder may be deposited on the surface of the lithium foil 102 and then embedding into the lithium foil 102 with the pressure processing machine 104. The embedding may be a lamination process to protect the outside or air boundary of the prelithiated substrate wherein the filler material is embedded, together with a liner material (not shown) into the lithium foil. The embedding may be achieved by, for example, rolling, pressing, crushing, extrusion, etc.

In an alternative embodiment, pressure processing may be performed individually for the lithium foil to obtain a predetermined lithium foil thickness and the filler material may be separately added. Thus, a plurality of different pressure processing machines 104 having different minimum material thickness limitations may be used. In one case, a process of calendering and annealing lithium can be performed to achieve a desired thickness and on the last calendering/annealing stage, the lithium may be placed on the substrate, and the filler material added prior to pressure processing the substrate-lithium-filler material article with a roller.

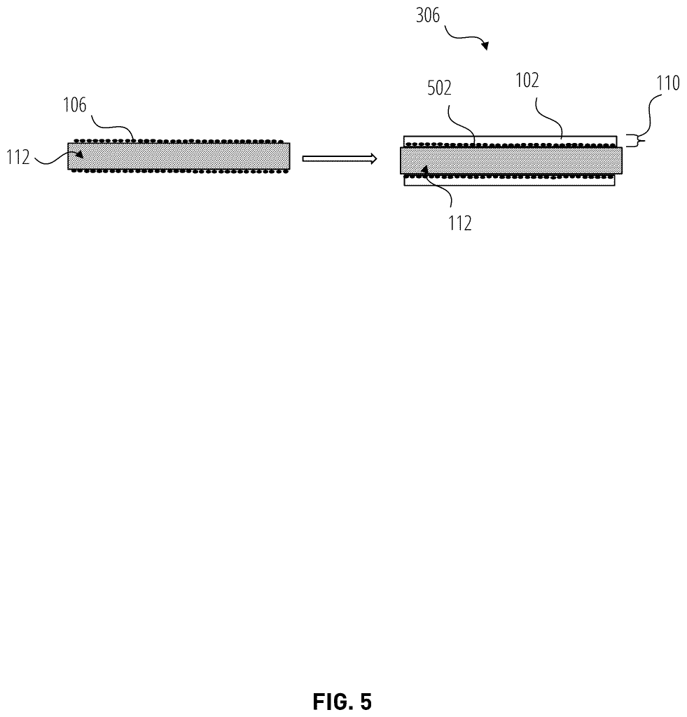

In another embodiment, as shown in FIG. 5, the lithium material is a lithium foil 102; and pressure processing the composite lithium onto one or both sides of the substrate includes sequentially bonding the filler material onto the substrate and the lithium onto the filler material.

More specifically, the filler material 106 may first be deposited on the substrate 112 and optionally pressure processed. The composite lithium 110 in this case comprises an interface filler material 502 and the lithium foil 102 may be formed by disposing the lithium foil 102 on the filler material 106. The interface filler material 502 may be located at the substrate-lithium foil interface or in some cases randomly embedded in the lithium foil. By passing the substrate 112 with the composite lithium 110 through the pressure processing machine 104 the composite lithium 110 may be bonded to the substrate 112. More specifically, the filler material 106 may be first deposited or bonded on the substrate 112 and the lithium foil 102 may subsequently be bonded to the filler material-substrate article. In some cases, the prelithiated substrate may also be laminated with a liner.

Thus, it can be seen from FIG. 3, FIG. 4 and FIG. 5 that the amount of lithium material needed for any prelithiation purpose can be correctly selected despite existing minimum material thickness limitations of the pressure processing machine 104 being used.

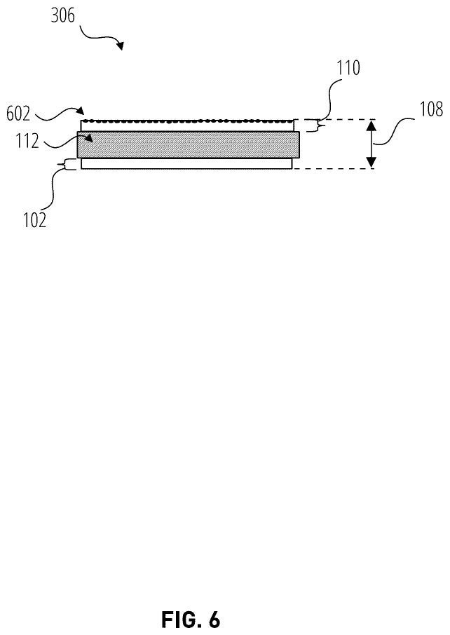

FIG. 6 illustrates a cross-sectional view of a prelithiated substrate 306 with the lithium composite on a first side 602 of the substrate in accordance with illustrative embodiments. The other side of the first side 602 may or may not have a lithium foil 102.

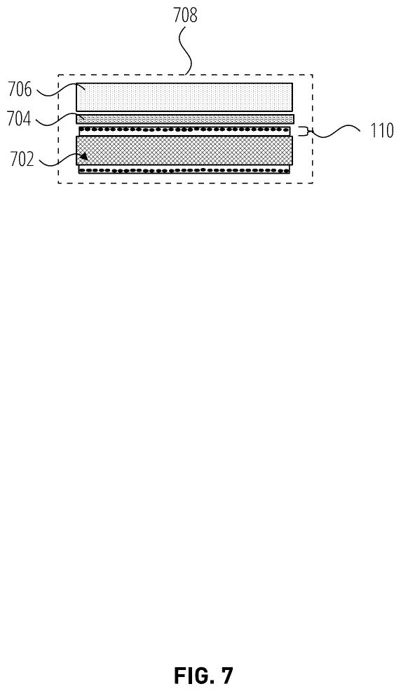

FIG. 7 illustrates a cross-sectional view of a cell 708 with cathode and/or cathode current collector substrate 702 in accordance with illustrative embodiments. A separator may be disposed between in the cathode and/or cathode current collector substrate 702 and the anode and/or anode current collector 706. A cathode as a substrate may comprise a material selected from the list consisting of, for example, LFP, LTO, LMO, LCO, NCA, LFMP and NCM.

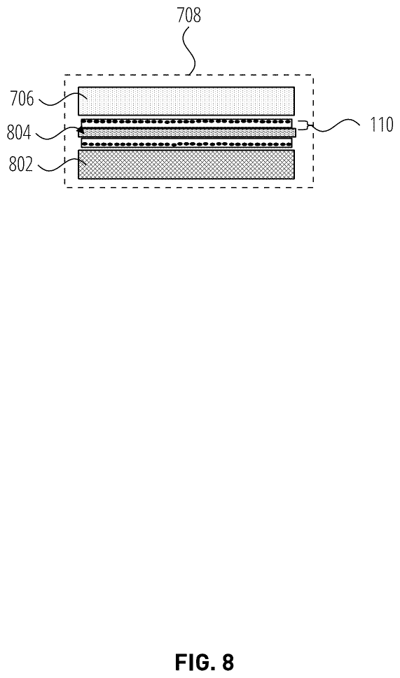

FIG. 8 depicts a cross-sectional view of a cell 708 with separator substrate 804 in accordance with illustrative embodiments. The separator substrate 804 may be disposed between the anode and/or anode current collector 706 and a cathode and/or cathode current collector 802.

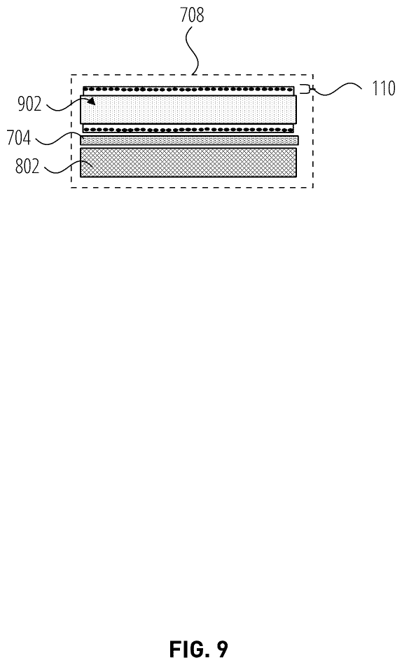

FIG. 9 illustrates a cross-sectional view of a cell 708 with an anode and/or anode current collector substrate 902 in accordance with illustrative embodiments. The cell 708 further comprises a separator 704 and a cathode and/or cathode current collector 802. In the case of a substrate comprising an anode, the anode may comprise a material selected from the list that includes, for example, Li, SiOx, TiO2, and C. A current collector substrate may also be used in some embodiments and may be an anode current collector such as Cu or a cathode current collector. More specifically, the cell 708 may be in some cases an anode-free cell. The substrate may also be made of an anode and an anode current collector (for example, a graphite anode laminated on a copper anode current collector).

### Example Computer Platform

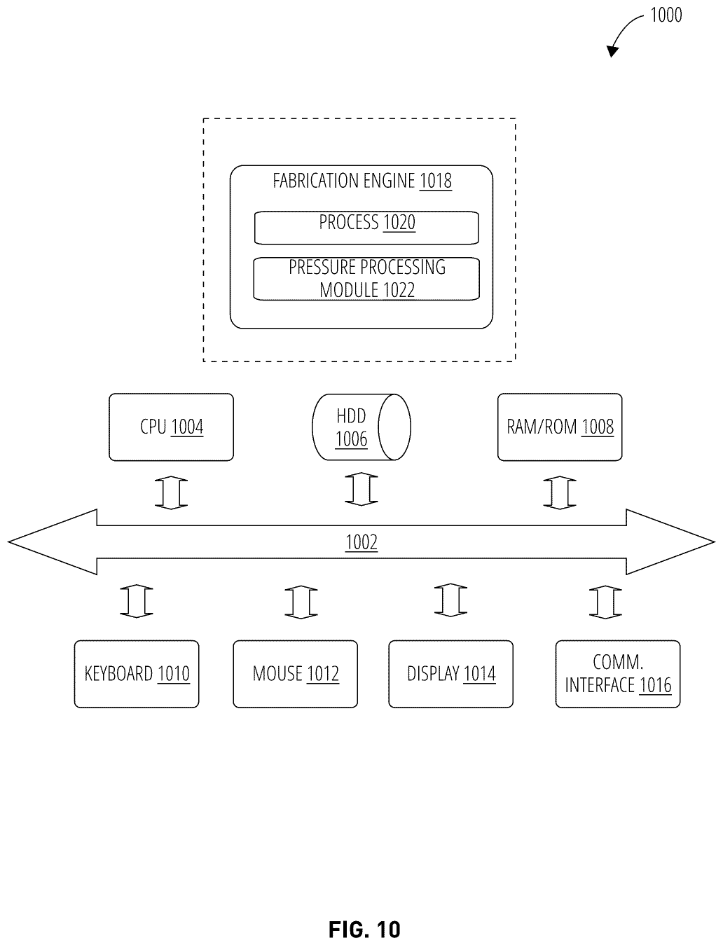

As discussed above, functions relating to methods and systems for prelithiating a cell using a pressure processing machine can use of one or more computing devices connected for data communication via wireless or wired communication. FIG. 10 is a functional block diagram illustration of a computer hardware platform that can be used to control various aspects of a suitable computing environment in which the process discussed herein can be controlled. While a single computing device is illustrated for simplicity, it will be understood that a combination of additional computing devices, program modules, and/or combination of hardware and software can be used as well. The computer platform 1000 may include a central processing unit (CPU) 1004, a hard disk drive (HDD) 1006, random access memory (RAM) and/or read only memory (ROM) 1008, a keyboard 1010, a mouse 1012, a display 1014, and a communication interface 1016, which are connected to a system bus 1002.

In one embodiment, the hard disk drive (HDD) 1006, has capabilities that include storing a program that can execute various processes, such as the fabrication engine 1018, in a manner described herein. The fabrication engine 1018 may have various modules configured to perform different functions. For example, there may be a process module 1020 configured to control the different manufacturing processes discussed herein and others. There may be a pressure processing module 1022 operative to provide an appropriate pressure, temperature, duration and or other process conditions for prelithiating a cell.

For the sake of brevity, conventional techniques related to making and using aspects of the invention may or may not be described in detail herein. In particular, various aspects of computing systems and specific computer programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method of prelithiating a cell with an initial amount of lithium comprising:
providing a substrate;
generating lithium and a filler material in an amount ratio of filler material to lithium for use as components of a composite lithium;
disposing, by pressure processing using a pressure processing machine, the lithium and the filler material onto the substrate; the disposing of the lithium and the filler material is performed at a same time or sequentially; and
placing the substrate with the composite lithium into the cell.

2. The method of claim 1, wherein performing the pressure processing using the pressure processing machine comprises calendering, hot pressing, laminating or roll bonding the lithium and the filler material onto the substrate.

3. The method of claim 1, further comprising:
meeting both (i) an active lithium content consideration of the cell during use and (ii) a minimum material thickness consideration of the pressure processing machine during manufacturing by sizing an amount of the filler material and the amount ratio to thicken the composite lithium to a thickness producible by the pressure processing machine while maintaining the initial amount of lithium material needed prior to a first charge-discharge cycle of the cell.

4. The method of claim 3, wherein after the first charge-discharge cycle of the cell, an active lithium content of the cell is enhanced by reducing or eliminating a net loss of lithium in a cathode of the cell.

5. The method of claim 3, wherein after the first charge-discharge cycle of the cell, an active lithium content of the cell is exceeded.

6. The method of claim 1, wherein:
the composite lithium is a mixture and the lithium is dispersed evenly throughout the composite lithium, and
the mixture is bonded onto the substrate.

7. The method of claim 1, wherein the lithium is a lithium foil; and
wherein pressure processing the composite lithium onto the substrate comprises sequentially bonding the lithium foil onto the substrate and the filler material onto the lithium foil.

8. The method of claim 1, wherein the lithium is a lithium foil; and
wherein pressure processing the composite lithium onto the substrate comprises sequentially bonding the filler material onto the substrate and the lithium onto the filler material.

9. The method of claim 1, wherein the filler material comprises one material or a plurality of different materials.

10. The method of claim 1, wherein the substrate comprises a substrate selected from the list consisting of: an anode, a separator, and a cathode.

11. A cell comprising:
a substrate; and
a layer of pressure processed composite lithium bonded on the substrate;
wherein the layer of pressure processed composite lithium comprises lithium and a filler material in a predetermined amount ratio of filler material to lithium.

12. The cell of claim 11, wherein the filler material includes at least one of a ceramic, a polymer, and a metal.

13. The cell of claim 12, wherein the filler material includes the ceramic and the ceramic is selected from the list consisting of Al₂O₃, and AlOOH.

14. The cell of claim 12, wherein the filler material includes the polymer and the polymer is selected from the list consisting of PAA, PMMA, PVDF, PP, and PE.

15. The cell of claim 11, wherein the filler material is inert, or reactive with lithium.

16. The cell of claim 11, wherein the substrate comprises a substrate selected from a list consisting of: an anode, a separator, and a cathode.

17. The cell of claim 16, wherein the substrate comprises an anode comprising a material selected from the list consisting of: Li, SiOx, TiO2, and C; or a cathode comprising a material selected from the list consisting of: LFP, LTO, LMO, LCO, and NCM.

18. The cell of claim 11, wherein the substrate comprises a current collector.

19. The cell of claim 11, wherein the cell is an anode-free cell.

20. The cell of claim 12, wherein the filler material includes Cu, Brass, Zn, Boehmite or SiO2.
